(19) United States
(12) Patent Application Publication
(10) Pub. No.: US 2011/0302015 A1
(43) Pub. Date: Dec. 8, 2011

(54) Paperless Coupon Distribution and Redemption System

(76) Inventors: Gary Keith Summers, Findlay, OH (US); Jeffrey Eric Wickenheiser, Calgary (CA)

(21) Appl. No.: 12/794,785

(22) Filed: Jun. 7, 2010

(51) Int. Cl. G06Q 30/00

(52) U.S. Cl. 705/14.25

(57) ABSTRACT

A paperless coupon redemption system, consisting of manufacturers or distributors loading coupons into a database for use by consumers. Consumers being able to access an internet interface to view, find and select coupons, and redeem them at the point of sale with an issued PVC card containing a unique reference number. The point of sale terminals are equipped with a hardware or software module which facilities the interaction between the POS machines and coupon database. The hardware and software modules work by collecting the UPC codes of products to be purchased, and transmitting these to a server along with the customer reference number. The server returns the UPC codes of applicable coupons, which are then transmitted into the POS system.

### BACKGROUND OF THE INVENTION

Presently, coupons are primary distributed in paper form. To redeem, consumers are required to clip, sort, store and retrieve these pieces of paper.

This method of redeeming paper coupons can be time consuming and be an inconvenience for consumers. Many are detracted from using coupons due to these needed steps.

For manufacturers, distributors and their respective parties, distributing coupons by paper (such flyers, product boxes, direct mailing) is expensive with a low redemption rate.

For these reasons, there is a need for an improved coupon distribution and redemption system.

### BRIEF SUMMARY OF THE INVENTION

A paperless coupon redemption system, consisting of the ability for coupons to be loaded into a database, for consumers (cardholders) to view and search this database, and for consumers to be able to redeem coupons from the database at the point of sale using a coupon card.

The system facilitates accepting coupon data from manufacturers, distributors or their representatives, and storing this information into a database. Consumers are able to access an internet based site to view, search and find coupons. Some of the coupons will be automatically available at the point of sale by using the coupon card (as determined by the manufacturer/distributor), the other coupons will need to be selected by the consumer to be available at the point of sale by using their card.

The coupon card consists of a PVC or similar card which contains a unique identification number, which may be printed in plain text, and also encoded as a barcode and/or magnetic stripe and/or radio frequency identifier. When this card is scanned, other the identification number otherwise inputted to the point of sale system, a custom module (either hardware or software) of the POS system will connect to an interface that interacts with the database and send the UPC codes of items to be purchased. The interface will interact with the database, and using the UPC codes and the customer identification number will return applicable coupons from those that are automatically applied and those that were selected by the consumer.

The custom module consists of one of two implementation choices. The first option is a hardware implementation. In this method, a physical module is added into the point of sale system on the barcode scanner and/or keyboard communication lines. The module records items as they are scanned/keyed into the POS, then recognizes when the consumer identification number is scanned/keyed, and proceeds to connect and send the needed data to the interface. The appropriate coupons are returned, and the module adds in these coupons so that the POS system believes they are being scanned/keyed in. The software module works by recognizing when the consumer identification has been scanned/keyed in, connecting to the interface, receiving the appropriate coupons, and applying them as appropriate directly in the POS software.

### DETAILED DESCRIPTION

A computer server or servers would run a database storing relevant information about coupons, such as, but not limited to: Issuing Company, Brand, Product, UPC Code, Start Date, Expiry Date, Number to be Issued, Maximum Uses per Customer, and Coupon Text. This data would be entered into the database by manufacturers, retailers, or other designated parties. Consumers (customers at retail or other stores, whether brick and mortar or online) would then be able to access the system through an interface, such as a website interface, to view coupons, and be able to redeem them through an integrated POS system as detailed below.

Consumers may use an interface, such as a website interface, to create an account with the system. Upon creation of such account, the consumer would be issued a card with a barcode, magnetic stripe, radio frequency identifier, plaintext or combination thereof.

The consumer may access the system to browse and search available coupons. The consumer can select coupons they wish to use at stores. In such cases where the number of coupons is limited in total number issued by the supplier of the coupon, the system can be configured so the consumer must select the coupon for use, and the selection can be recorded and the number available for the particular coupon can be reduced in the database. In such cases where there is a maximum number of uses per customer, the uses are recorded and checked upon each use of the coupon card, so that each coupon cannot be redeemed more than the allowable limit.

Technology to support this system must be implemented at point of sale (POS) terminals where it will be used. Depending on the specifications of the retail or other store, the coupon system can operate in two ways, either using a hardware or software module.

The hardware module, including a processing unit, UPC tie-in unit, customer pad and network/phone connection. Setup of this system requires a UPC tie-in unit, such that the UPC scanner cable data line be routed through part of the coupon hardware device, allowing data to be collected by the coupon hardware device, and allowing the coupon hardware device to send data on this line. The coupon hardware device will also be required to be connected to a communication line, either an internet protocol connection, transmission control protocol, internet, phone connection or combination thereof, which may or may not be facilitated by wireless devices. Items scanned using the UPC barcode reader of the POS system will be logged into memory of the coupon hardware system, using the UPC tie-in line. After all items have been scanned, the consumer, sales associate or other agent or automated process would scan, swipe or pass their coupon card or type in the customer reference identification number. The device will detect the unique string of digits that indicate the entered data represents a customer identification number. The coupon hardware device would then connect, using IP, TCP, internet and/or phone, to the coupon server, sending the card identification number and the UPC codes of all products scanned. The server would match applicable coupons to the UPC codes received, and return the coupon UPC codes to the coupon hardware system. The coupon hardware system would then send the UPC codes of the applicable coupons to the POS system by putting the UPC codes onto the UPC data line using the UPC tie-in device, where the POS system would recognize and handle the processing of the coupon.

Point of sale software module. The POS machine will also be required to be connected to a communication line, either an internet protocol connection, transmission control protocol, internet, phone connection or combination thereof, which may or may not be facilitated by wireless devices. Software changes within the POS system are made, so that during the product scanning or select process, the coupon card can be scanned, swiped or passed over a card reader or the identification number can be entered manually. The POS system would connect, using IP, TCP, internet and/or phone, to the coupon server, sending the customer reference identification number and the UPC codes of all products scanned or selected. The server would match applicable coupons to the UPC codes received, and return these codes to the POS system, which would handle the processing of the coupons.

In both of these system configurations, traditional paper coupons would not be affected and would still be able to be handled by the POS system as normal.

When a connection is received by the server from a hardware or software module, the server will perform verification checks on the data to ensure the connection is from an actual coupon module and has not been tampered with. The server then performs database queries, using the customer reference identification number, to retrieve coupons that have been selected by the consumer and are relevant to product UPC codes that were received as part of the transmission. Any coupons that are also relevant to received product UPC codes that have been selected to be automatically applied by the manufacturer, distributor or representative thereof, will also be retrieved. Both these sets of coupons will have their UPC numbers then be transmitted back to the hardware or software module, which then facilitate the passing of the coupon UPC numbers into the POS system.

The coupon servers can reference UPC codes of all items scanned at a POS system to consumer accounts, with all transactions being logged. Analysis can be performed on this data, such as giving the ability to show which and how many coupons are used, as well as the ability to analyze consumer buying trends, with the ability to factor in demographics and other personal details.

BRIEF DESCRIPTION OF THE DRAWING

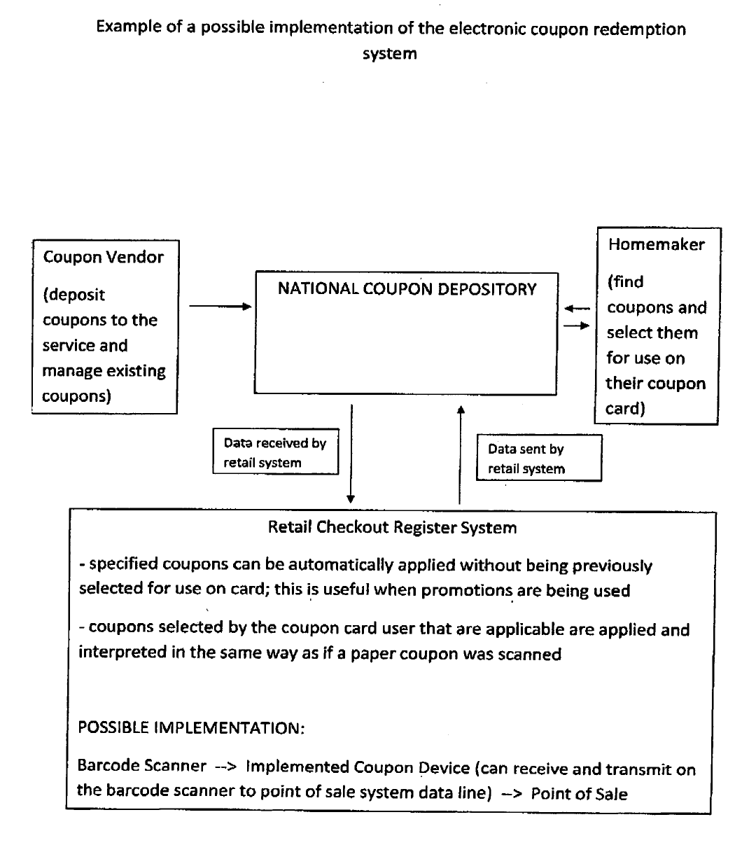

FIG. 1 shows one way the system can be used, with multiple components of the system being shown.

### DETAILS DESCRIPTION OF THE DRAWING

Referring now to Drawing 1, the central box, labelled “NATIONAL COUPON DEPOSITORY” represents the servers and database that store coupon, customer and store information and is the system the stores, customers and applications connect to. The left “Coupon Vendor” boxes represent that coupon vendors, such as manufacturers, are one such entity that can load certain information into the central databases. The right “Homemaker” image shows that a consumer, such as a homemaker, would connect to the central application, possibly through a web interface to receive information about available coupons. They will then be able to send data to the server, most likely by using a web page, to find and select coupons to become available on their card. The bottom box, labelled “Retail Checkout Register System” shows one possible store setup with a hardware module. It shows how in-store tagging takes advantage of the “automatic” coupon availability feature. It shows how the point of sale machine interacts with the central applications and database to send and receive data, and how the hardware device is connected to the scanner and point of sale machine.

1. A system for providing paperless coupon redemption comprising: a database that stores coupons and their details; a process for manufacturers, distributors or others to add, remove or modify certain information in the database; a process for consumers, or cardholders, to view certain information in the database; a process for consumers, or cardholders, to view coupons that are automatically available to them and to select other coupons for use that are not automatically applied; a card containing a unique reference for the customer, with relation to their personal information, coupon usage and coupons selected; to have hardware or software systems in place at participating retailers that allow for products being purchased to be transmitted along with the customer reference number, and to handle a response, leading to applicable coupons being transmitted into the POS system; an interface that handles the transmissions from the POS hardware and/or software, performs queries on the database to determine applicable coupons, and responds with those coupons.

2. The system of claim 1 in which data is stored within at least one relational database.

3. The system of claim 2 in which communication with the database is handled by scripts on one or more central servers.

4. The system of claim 3 in which manufacturers, distributors, others or representatives thereof interface with the scripts by internet protocol, transmission control protocol, file transfer protocol, internet, email, webpage, script, phone, and any combination thereof.

5. The system of claim 2 in which consumers, or cardholders, can create or modify their information, view applicable coupons in the database, view coupons that are automatically usable on their card, and select coupons available in the database to be useable on their card.

6. The system of claim 1 in which a PVC or similar card is issued to the consumer, and this card contains in plain text, barcode, UPC, magnetic stripe, radio frequency identifier, and any combination thereof the reference number for the consumer.

7. The system of claim 3 in which a hardware module or software module is installed at the point of sale systems of participating retailers, where the module logs and transmits scanned/keyed products to be purchased along with the consumer reference number to the central servers over internet protocol, transmission control protocol, internet, script or phone, where the returned result is coupon UPC codes that are inputted to the POS terminal.

8. The system of claim 3 in which data transmission from the hardware or software module is received, the applicable coupons are determined and coupon UPC codes are transmitted back to the hardware or software module.

9. The system of claim 2 where coupon data stored includes coupon UPC, start and expiry dates, relevant product UPC codes, maximum number of uses, whether or not the coupon is automatically available, and other options and restrictions.

10. The system of claim 8 where received data can be logged into a database.

11. The system of claim 10 where data can be analyzed and cross referenced to consumer profiles, providing a means of analyzing purchasing habits with the ability to reference to demographics and personal details.
